(19) United States
(12) Patent Application Publication
(10) Pub. No.: US 2006/0144655 A1
(43) Pub. Date: Jul. 6, 2006

(54) Disc brake pad

(76) Inventor: A. P. Lin, Chang Hwa City (TW)

Correspondence Address: CHARLES E. BAXLEY, ESQ., 90 JOHN STREET, THIRD FLOOR, NEW YORK, NY, 10038, US

(21) Appl. No.: 11/031,594

(22) Filed: Jan. 6, 2005

(51) Int. Cl. F16D 69/00

(52) U.S. Cl. 188/251 A

(57) ABSTRACT

A disc brake pad comprises: a support board coated at a side surface thereof with epoxy resin, and a friction member is press formed out of a compound of alumina, Kevlar, graphite and resin and then affixed to side surface of the support board by hot pressing, so that the epoxy resin will be melted and polymerized to combine the support board with the friction member as a whole, whereby the disc brake pad does not excessively wear the disc rotor during deceleration and stopping of the disc rotor while maintaining good performance in wet conditions.

### BACKGROUND OF THE INVENTION

1. Field of the Invention

The present invention relates to a bicycle brake pad, and more particularly to a bicycle disc brake pad.

2. Description of the Prior Arts

Bicycle braking devices are used to stop or decelerate a bicycle, and include many types: caliper brake, cantilever brake, disc brake and the like. The disc brake has been commonly used on the bicycle, which comprises a disc rotor mounted on the rear or the front wheel, and a brake assembly mounted on the frame of a bicycle. The brake assembly is provided with a pair of brake pads located at both sides of the disc rotor. By pulling the brake line, the brake pads will be actuated to clamp the disc rotor from both sides, so that the hub fixed at the center of the disc rotor and the wheel on the hub will be caused to stop. Therefore, the brake pad is an indispensable component of the disc brake device.

The brake pad of any disc brake device is comprised of a friction member formed on a metal plate, the friction member is typically molded from a rubber that is cross-linked with sulfur and used to contact side surface of a disc rotor. The side surface of the disc rotor is hard and smooth since it is anodized, which results in good braking performance in dry conditions, but poor braking performance in wet conditions. The conventional rubber brake pad only can provide good braking performance in dry conditions.

Attempts have been made to improve braking performance, especially in wet conditions, by manufacturing rubber brake shoes with refractory fillers. For example, rubber brake pads have been manufactured with alumina (Al₂O₃). While such improved rubber brake pads provide good wet and dry performance, such brake pads with alumina cause too much wear of side surfaces in the anodized disc rotor.

The present invention has arisen to mitigate and/or obviate the afore-described disadvantages.

### SUMMARY OF THE INVENTION

The primary objective of the present invention is to provide a bicycle disc brake pad that has improved braking performance in wet conditions.

The secondary object of the present invention is to provide bicycle disc brake pad that does not excessively wear the rim during deceleration or stopping of the rim by the bicycle brake shoes braking while maintaining good performance in wet conditions.

A disc brake pad provided in accordance with the present invention comprises:

a support board coated at a side surface thereof with epoxy resin;

a friction member being press formed out of a compound of alumina, Kevlar, graphite and resin and then being affixed to side surface of the support board by hot pressing, so that the epoxy resin will be melted and polymerized to combine the support board with the friction member as a whole, whereby the disc brake pad does not excessively wear the disc rotor during deceleration and stopping of the disc rotor while maintaining good performance in wet conditions.

The support board is press forged to conform to the shape of a disc brake device, the support board and the friction member will be treated with a grinding process and a finishing process after being fixed together by hot pressing, the grinding process is a process for grinding the friction member to a specific thickness, and the finishing process is a process for applying anti-rust treatment to the support board.

The present invention will become more obvious from the following description when taken in connection with the accompanying drawings, which show, for purpose of illustrations only, a preferred embodiment in accordance with the present invention.

### BRIEF DESCRIPTION OF THE DRAWINGS

FIG. 1 is an exploded view of showing a brake pad and a disc brake assembly thereof in accordance with the present invention;

FIG. 2 is a perspective view of the disc brake pad in accordance with the present invention;

FIG. 3 shows disc brake pad manufacturing processes in accordance with the present invention;

FIG. 4 is a perspective view of another disc brake pad in accordance with the present invention;

FIG. 5 is a perspective view of another disc brake pad in accordance with the present invention.

### DETAILED DESCRIPTION OF THE PREFERRED EMBODIMENTS

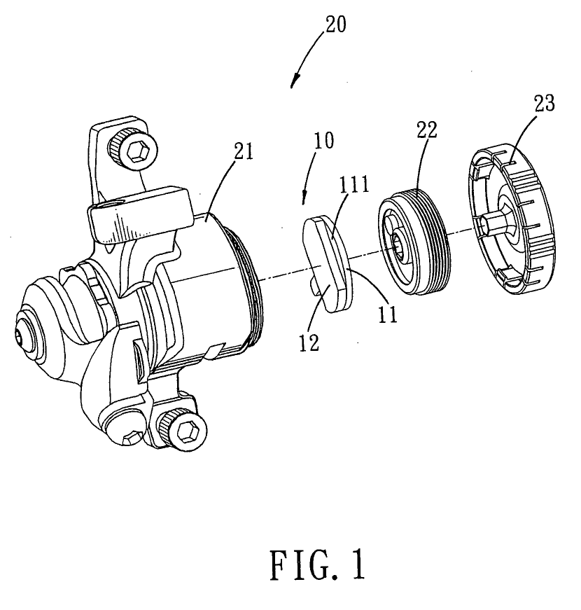

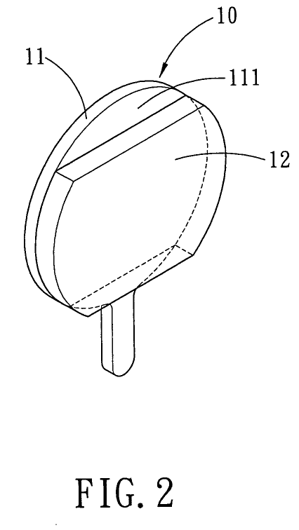

Referring to FIGS. 1 and 2, a disc brake pad 10 provided in accordance with the present invention is shown, which is disposed in a housing 21 of a disc brake assembly 20 and is confined therein by an adjusting member 22 and a cover 23. Since the disc brake pad 10 and the disc brake assembly 20 are of conventional type, further remarks would be omitted. The disc brake pad 10 comprises a support plate 11 and a friction member 12.

The support board 11 is coated at side surface 111 with epoxy resin, and the support board 11 can be made of metal, alloy or composite material. The support board 11 is press forged in the shape of the disc brake assembly.

The friction member 12 is press formed out of the compound of alumina, Kevlar, graphite and resin, and then is affixed to the side surface 111 of the support board 11 by hot pressing, so that the epoxy resin will be melted and polymerized to connect the support board 11 with the friction member 12 as a whole. The resin can be Rubber Modified Phenolic Resin.

Hence, the disc brake pad 10 does not excessively wear the disc rotor during deceleration or stopping of the disc rotor while maintaining good performance in wet conditions, so that the disc rotor can be used for a long period of time without being replaced frequently.

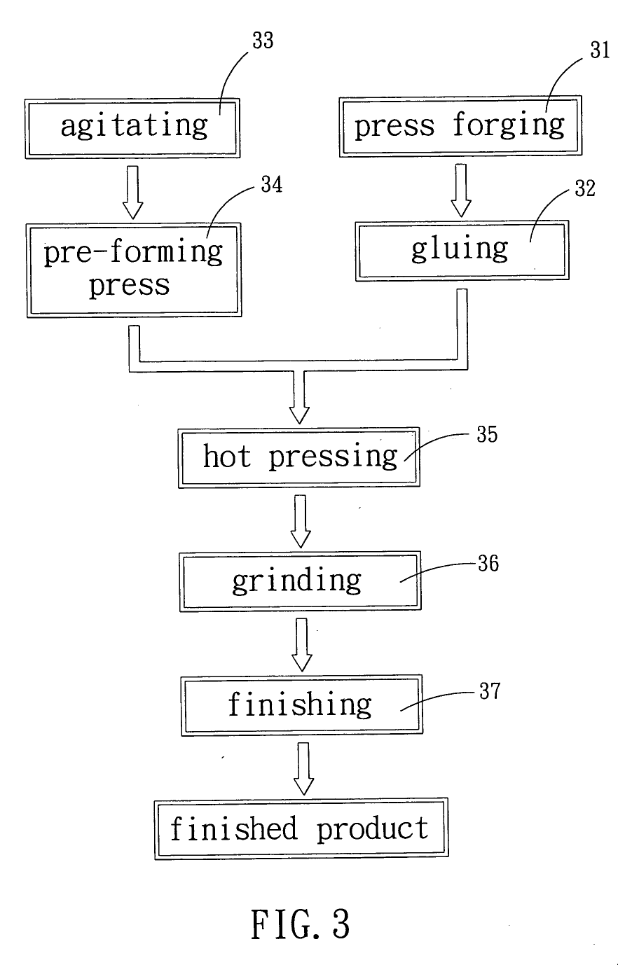

Referring to FIG. 3, which shows disc brake pad manufacturing processes, including: press forging 31, gluing 32, agitating 33, pre-forming press 34, hot pressing 35, grinding 36, finishing 37.

The press forging 31 is a process for producing the support board which is press forged according to the shape of the disc brake assembly.

The gluing 32 is a process for applying epoxy resin to a side surface of support board.

The agitating 33 is a process for agitating and mixing the alumina, the Kevlar, the graphite and the resin together, and then mixture of the alumina, the Kevlar, the graphite and the resin is made into a desired shaped friction member in the pre-forming press 34.

The hot pressing 35 is a process for fixing the friction member to the support board, by heating, the epoxy resin will be melted and polymerized to combine the support board with the friction member as a whole.

The grinding 36 is a process applied to the combination of the friction member and the support board, and more particularly to the friction member for grinding it to a specific thickness.

The finishing 37 is a process applied to the ground combination of the friction member and the support board, and more particularly to the ground support board, for applying anti-rust treatment to the ground support board so as to prevent it from rust and corrosion. For example, forming an isolation layer on surface of support board by paint spraying treatment.

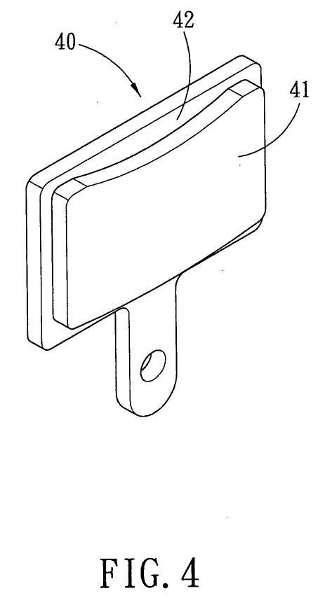

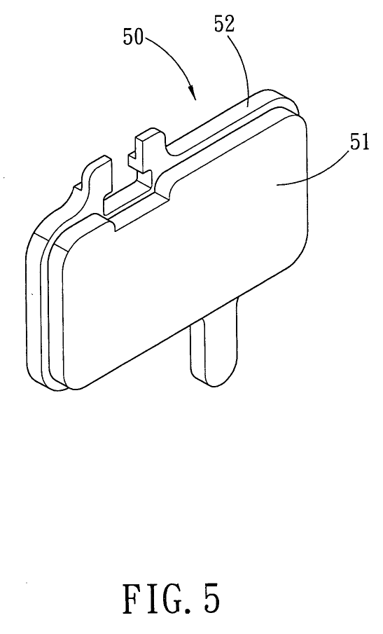

Referring further to FIGS. 4 and 5, a support board 41, 51 and a friction member 42, 52 of a disc brake pad 40, 50 in accordance with the present invention can be formed in the shape of the disc brake device. In other words, the support board 41, 51 and the friction member 42, 52 of the disc brake pad 40, 50 will change with the changes in operating manner of the disc brake device.

While we have shown and described various embodiments in accordance with the present invention, it should be clear to those skilled in the art that further embodiments may be made without departing from the scope of the present invention.

1. A disc brake pad comprising:
a support board coated at a side surface thereof with epoxy resin;
a friction member being press formed out of a compound of alumina, Kevlar fiber, graphite and resin, and then being affixed to side surface of the support board by hot pressing, so that the epoxy resin will be bonded and polymerized to combine the support board with the friction member as a whole, whereby the disc brake pad does not excessively wear the disc rotor during deceleration and stopping of the disc rotor while maintaining good performance in wet conditions.

2. (canceled)

3. (canceled)

4. (canceled)

5. The disc brake pad as claimed in claim 1, wherein the support board is press forged to conform to the shape of a disc brake device.

6. The disc brake pad as claimed in claim 1, wherein the resin of the friction member is Rubber Modified Phenolic Resin.

7. The disc brake pad as claimed in claim 1, wherein the support board and the friction member will be treated with a grinding process and a finishing process after being fixed together by hot pressing.

8. The disc brake pad as claimed in claim 7, wherein the grinding process is a process for grinding the friction member to a specific thickness.

9. (canceled)

10. (canceled)

11. The disc brake pad as claimed in claim 1, wherein the resin of the friction member is epoxy resin.
